(19) United States
(12) Patent Application Publication
(10) Pub. No.: US 2003/0200220 A1
(43) Pub. Date: Oct. 23, 2003

(54) Method, system, and program product for the implementation of an attributegroup to aggregate the predefined attributes for an information entity within a content management system

(75) Inventors: Tawei Hu, San Jose, CA (US); Lily Liang, San Jose, CA (US); Kenneth Carlin Nelson, Hollister, CA (US); Li-Ming A. Wang, Darnestown, MD (US); Howard Hao Zhang, San Jose, CA (US)

Correspondence Address: INTERNATIONAL BUSINESS MACHINES CORP, IP LAW, 555 BAILEY AVENUE , J46/G4, SAN JOSE, CA, 95141, US

(73) Assignee: International Business Machines Corporation, Armonk, NY (US)

(21) Appl. No.: 10/131,065

(22) Filed: Apr. 23, 2002

(51) Int. Cl. G06F 7/00

(52) U.S. Cl. 707/100

(57) ABSTRACT

A database management system, method, and program product for managing a relational database of items. Each of the items has a plurality of attributes, and the relational database is adapted to operate on the items as a function of the attributes of an item. According to our invention the attributes are arrayed in a hierarchal array of attributes and levels of attribute groups, such that an attribute group contains one or more attributes. According to our invention an attribute is contained in only one first level attribute group, and an intermediate attribute group is contained in only one attribute group at a next higher level. In a preferred embodiment of our invention the items are content items.

### FIELD OF THE INVENTION

The invention relates to database management systems and especially to creating and maintaining a record of data attributes (parameters) as an aid in querying.

### BACKGROUND OF THE INVENTION

As used herein, an “attribute” is a property or characteristic, and more particularly an “attribute” is a field of a database. Formally, an “attribute” is a function which maps from an entity set (that is, entities of the same type, such as all persons having an account at a bank can be defined as the entity set “customer,” or all accounts in a particular bank may be represented by the entity set “account”), where an entity us represented by a set of “attributes”, such as “customer name,” “social security number,” “street address,” “city,” “account number” and “balance.” Every entity is described by a set of (attribute, data value) pairs, with one such pair for each attribute of the entity set. By way of example, a particular customer entity would be described by the set of attribute-data value pairs {(name, John Q. Public), (social security number, 123-45-6789), (street address, 555 Bailey Road), (city, San Jose)}, the described customer having the attributes name, social security number, street address, and city, and the data values John Q. Public, 123-45-6789, 555 Bailey Road, and San Jose.

Databases and content management servers store many items, i.e., items of data and content. An item, be it data or content, is the sum of its attributes and can be represented by its attributes.

Content Management is an infrastructure to manage the full spectrum of digital information. Large collections of scanned images, facsimiles, electronic office documents, XML and HTML files, computer output, audio, video, multimedia, and virtual reality content can be stored and accessed through the content management system. The content management system integrates content with line of business, customer service, ERP, digital asset management, distance learning, Web content management or other applications to accelerate benefits across the enterprise.

In one embodiment the content manager product may be visualized as a triangle, its three vertices being the client, a library server and an object server (resource manager). The client is the user's interface which gives the user the capability of storing, searching for, and, marking-up documents (or to use the more general term, objects). The library server is the equivalent of a card catalog which holds information about the objects, including their location. The object server (OS), also referred to herein as the resource manager (RM) is where either the actual object or a pointer to the actual object is stored.

The core Library Server logic (except for system utilities and housekeeping tasks) is packaged as a set of relational data base (RDB) stored procedures (SPs) containing embedded SQL statements. Each stored procedure (SP) is precompiled and runs on a relational database (RDB) server. Thus each Library Server (LS) process is merely a relational database (RDB) server process. The interface to a Library Server is SQL, through which either stored procedures (SPs) can be called or SQL SELECT statements (including cursor support) can be executed. Remote access to Library Server is via a relational database (RDB) client.

The Resource Managers (RMs) may support different/multiple access protocols. The resource manager (RM)—object server (OS) supports the HTTP protocol. The basic information entities managed by the Library Server are “items.” “Items” as used herein come in two types, simple items and resource items. Resource items can have content associated with them that is stored in one or more Resource Managers. Resource items point to their content via Resource URL-RELATED DATA. One attribute of “items” is their “folder.”

The library server (LS) and object server (OS) (resource manager (RM)) are separate processes, often running on different machines. In operation, clients first contact the library server (LS) to create/update an index for an object, and to determine where the object is to be stored/replaced. The client then sends a request to the object server (OS) to store/replace the object.

To keep track of data entries, tens or hundreds attributes (parameters) may be defined to a database management system (DBMS). For example, a meaningful information entity may have multiple attributes associated with it. It is also frequently necessary to add, change, and delete the attributes associated with an information entity.

In the mean time the order and relationship between the attributes has to be maintained. For example a set of attributes are associated with the auto part such as: part name, model, serial number, location, and depot. If two additional attributes, Category and Section, have to be included in the attributes of auto part a new sequence, as part name, Category, model, serial number, location, Section, and depot, then all existing attributes associated with the auto part should be retrieved, and the two additional attributes inserted in the required order. This is a non-trivial change in a dynamic system.

### SUMMARY OF THE INVENTION

According to our invention, these changes are readily accommodated. Specifically, this is accomplished by a database management system comprising a relational database of items. Each of the items has a plurality of attributes, and the relational database is adapted to operate on the items as a function of the attributes of an item. According to our invention the attributes are arrayed in a hierarchal array of attributes and levels of attribute groups, such that an attribute group contains one or more attributes. According to our invention an attribute is contained in only one first level attribute group, and an intermediate attribute group is contained in only one attribute group at a next higher level. In a preferred embodiment of our invention the items are content items.

A further aspect of our invention is a method of managing items in a relational database management system. The items are characterized by attributes, and the relational database is adapted to operate on items as a function of the attributes of an item,. The method comprises arraying the attributes in a hierarchal array of attributes and levels of attribute groups, so that an attribute group contains one or more attributes.

A still further aspect of our invention is a program product comprising computer readable program code on a medium. The computer readable program code is adapted to configure and control one or ore computers to operate a relational database of items, where each of the items has a plurality of attributes. The relational database operates on items as a function of the attributes of an item, with the computer readable program code arraying the attributes in a hierarchal array of the attributes and levels of attribute groups, wherein an attribute group contains one or more attributes. The program code is adapted to array the attributes so that an attribute is contained in only one first level attribute group, and so that an intermediate attribute group is contained in only one attribute group at a next higher level. Un a content management system the items are content items.

The computer readable program may be compressed, encrypted, or compressed and encrypted and require installation to control and configure the one or more computers.

### THE TABLES AND FIGURES

TABLE 1 illustrates attributes and AttributeGroupsassigned to a hypothetical automobile part before change.

TABLE 2 illustrates attributes and AttributeGroupsassigned to a hypothetical automobile part after change.

FIG. 1 is an overview of the three elements of a content management system, the client application, the library server, and the resource manager, and the actions between them in storing and replacing an item.

FIG. 2 illustrates a simple hierarchy of two levels of attribute groups.

FIG. 3 illustrates the extensibility of the structure of FIG. 2, with the addition of two attributes.

FIG. 4 illustrates a four level hierarchy of attribute groups.

FIG. 5 illustrates a database of relational database tables connected through respective primary keys and foreign keys.

### DETAILED DESCRIPTION OF THE INVENTION

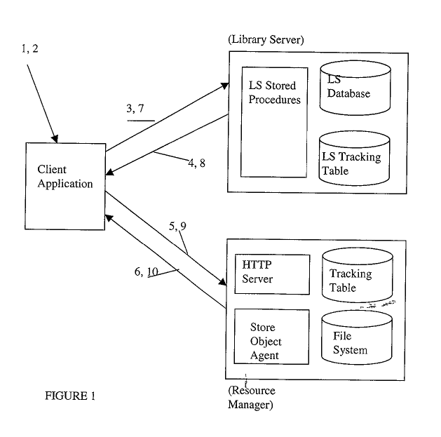

FIG. 1 illustrates the client, the library server, and the resource server, and how they interact to store an item. As shown in the FIGURE, a client application, a library server, and a resource manager are running. The library server includes library server stored procedures, a library server database, and a library server tracking table. The resource manager includes an HTTP server, a Content Management resource manager “Store Object” agent, a resource manager tracking table data base, and a file system.

At a high level, the client begins a transaction, 1, and returns confirmation to the end user, 2. Next, the client establishes a connection to the library server, and sends requests to the library server to create a catalog entry (as an index entry) for a content management object, 3. In response, the client receives information back from the library server as to where to store the object, 4. The client then sends a request to the resource manager to store the object, 5. The client receives a response, 6, from the resource manager with object metadata. This metadata includes, by way of exemplification, the object name, size, and creation timestamp. The client sends this metadata to the library server, 7. The library server replies to the client indicating success or failure of the of the metadata update, 8, at which point the client commits the library server updates, 9. After committing the library server updates, the client requests the resource manager to delete its tracking table record. The client receives a reply from the resource manager indicating success or failure in deleting the tracking table entry, 10.

Items and objects are stored, accessed, retrieved, and operated on based upon attributes. More particularly, in order to keep track of data entries, tens or hundreds attributes (parameters) may be defined to a database management system (DBMS).

Within this context, it is frequently necessary to add, change, and delete the attributes associated with an information entity, while maintaining the order and relationship between the attributes. For example if a set of attributes are associated with a part such as: part name, model, serial number, location, and depot, and two additional attributes, Category and Section, have to be included in the attributes of the part, then a new sequence, as part name, Category, model, serial number, location, Section, and depot, is created, and all of the existing attributes associated with the part need to be retrieved, and the two additional attributes inserted in the required order. This has heretofore been a serious issue, especially for a non-trivial change in a dynamic system.

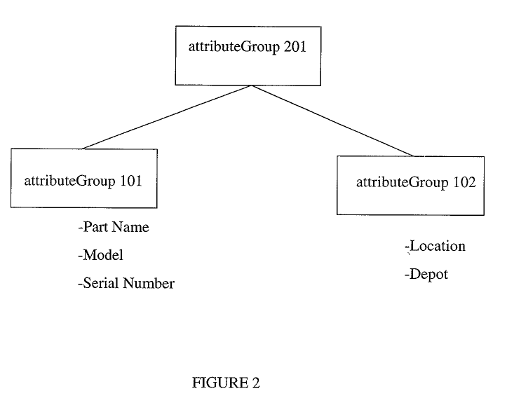

To resolve the difficulties of attribute maintenance we provide, as shown in FIG. 2, $$$$$ a high level, multi-attribute, attribute. This high level attribute is a store of a plurality of low level attributes. This high level attribute is referred to herein as an AttributeGroup. The AttributeGroup aggregates all or a subset of the required attributes (with their sequence numbers) into one attribute group. The AttributeGroup and attributes are unique within the content manager system, that is, an attribute or AttributeGroup is used only once within a DBMS. An attribute may be added, replaced, or deleted from the AttributeGroup.

According to one exemplification of our invention, there is only one level of attribute groups, and no attribute group is contained within another attribute group. According to an alternative exemplification of our invention, the AttributeGroup may be contained in a next higher level AttributeGroup, that is, the attribute groups may be nested or hierarchal.

A one level AttributeGroup for automobile parts is illustrated in Tables 1 and 2. These two tables illustrate the hierarchical relationship between an Attribute Group and its contained or member attributes. To implement the concept of AttributeGroup, the auto part can be represented by one AttributeGroup AttributeGroup 201 or two AttributeGroups, AttributeGroup 101 and ArributeGroup 102 as the table 1. After inserting two new attributes, the AttributeGroups defined to the auto part still remain the same as the AttributeGroups in Table 2.

The invention provides the simplicity to maintain the relationship between the AttributeGroup and attributes. The attributes are always defined and maintained in the lowest level AttributeGroup. An item is the sum of its attributes and can be represented by the its level AttributeGroup.

The invention provides the data integrity between the AttributeGroup and attributes. All attributes and AttrributeGroups defined for an item should be predefined and activated in the information system.

The invention provides the flexibility to change the relationship between AttributeGroup and attributes. Any level AttributeGroup can be changed without impacting the hierarchical relationship between the AttributeGroup and its associated attributes.

The implementation of AttributeGroup will build the hierarchical relationship between the AttributeGroup and attributes. The information entity can be represented by the different level AttributeGroups and attributes. Each AttributeGroup represents a set of attributes, preferably related, and aggregates all required attributes. When doing an add, update, and delete operation to any attributes within the AttributeGroup, the operation will not impact the relationship with other AttributeGroups.

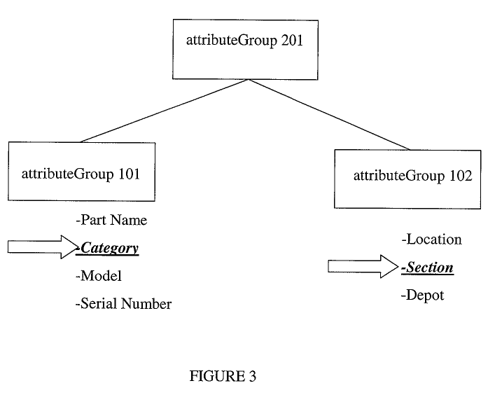

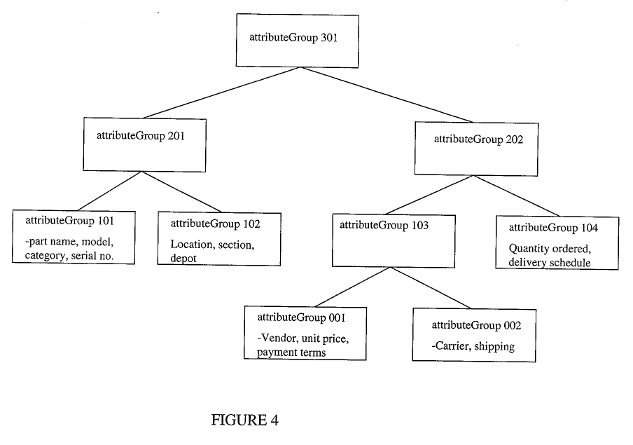

Conceptually, as shown in FIGS. 2, 3, and 4, the method, system, and program product of our invention utilize a high level model that is able to support a diverse and open set of content application requirements and a plurality of high level data models, and a low level physical model of the data content, and provides efficient mapping to the data engine (a database management system, as a relational database management system or an object oriented database management system, by way of example and not limitation). To be noted is that each high level attribute group data model that is hierarchal (and taxonomic) and becomes increasingly granular as one progresses down the hierarchy from the highest level of attributeGroups to the lowest level of raw data. Also to be noted is that the lower level data can be represented, accessed, stored, searched, and retrieved through multiple high level attributes and attributeGroups. The extensible and scalable content management system of the invention contains one or more levels of attributeGroups supporting representing disparate combinations and permutations of low level raw data items.

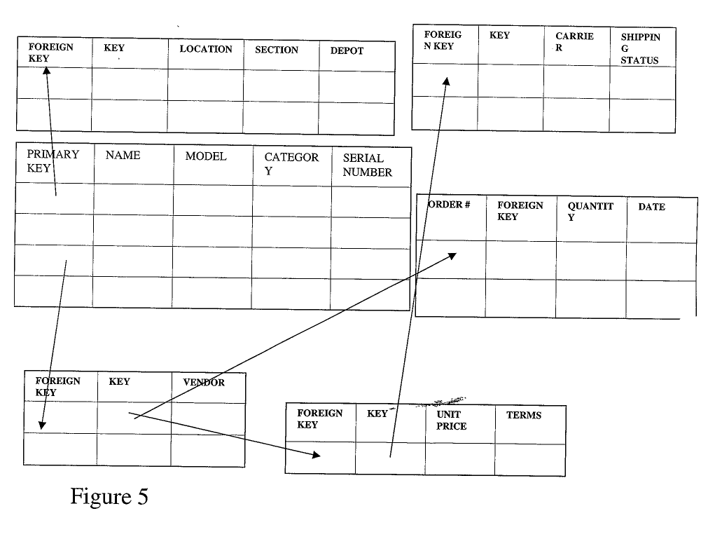

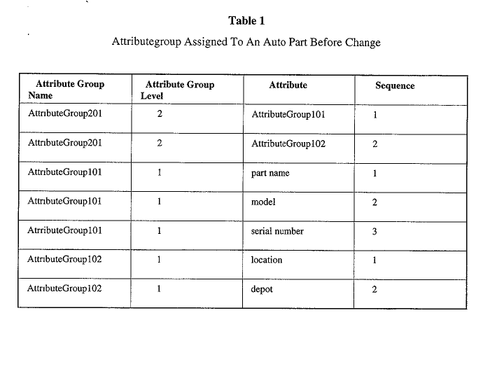

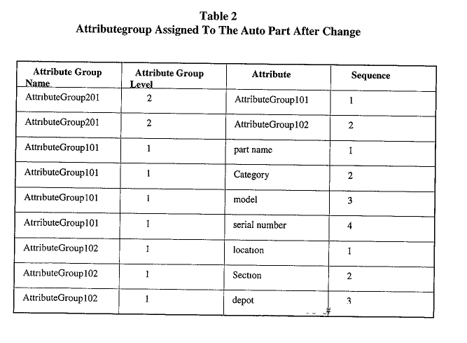

FIGS. 2, 3 and 4 illustrate the relationships between the low level, raw or physical data and its representation in a RDBMS environment, and extensibility and scalability of the Attributes and AttributeGroups as data structures. In a relational database data is represented as tables, as illustrated in FIG. 5. The building blocks of a relational database table are tables of rows and columns (attributes). Specifically, as shown in FIG. 5, a table consists of a row of column headings together with zero or more rows of data values. For a given table (1) the column heading specifies one or more columns, and (2) each data row contains exactly one value (or a null value) for each one of the columns specified in the column heading row.

The primary, standalone unit of content managed by the content management system of the invention is an “Item.” The item is a cell in a relational database table, and the hierarchal system of Attributes and attributeGroups. In the system of FIGS. 2, 3, and 4, and TABLES 1 and 2, the “Item” is an automobile part, that is, a relational database row, and the “Attributes” are the attributes of the part, that is, cells in the row (or in cells in rows logically joined through SQL “join” operations (the arrows of FIG. 5). For example, the attributes can be the part name, the model, the category, the serial number, the physical location of the part, the section, the part depot, the vendor, the unit price, the payment terms, the carrier, the shipping cost, the quantity ordered, and the delivery schedule.

A program product is computer readable program code on one or more media, said program code being capable of controlling and configuring a computer system having one or more computers.

The one or more computers may be configured and controlled to carry out the method described herein. Alternatively, the program may be one or more of encrypted or compressed for subsequent installation, and may be resident on media or on an installation server.

While our invention has been described with respect to certain preferred embodiments and exemplifications, it is not intended to be limited thereby, but solely by the claims appended hereto.

We claim:

1. A database management system comprising a relational database of items, each of said items having a plurality of attributes, said relational database being adapted to operate on items as a function of the attributes of an item, said attributes being arrayed in a hierarchal array of attributes and levels of attribute groups, and wherein an attribute group contains one or more attributes.

2. The database management system of claim 1 wherein an attribute is contained in only one first level attribute group.

3. The database management system of claim 1 wherein an intermediate attribute group is contained in only one attribute group at a next higher level.

4. The database management system of claim 1 wherein the items are content items.

5. A method of managing items in a relational database management system, wherein said items are characterized by attributes, said relational database being adapted to operate on items as a function of the attributes of an item, said method comprising arraying said attributes in a hierarchal array of attributes and levels of attribute groups, and wherein an attribute group contains one or more attributes.

6. The method of claim 5 comprising placing an attribute in only one first level attribute group.

7. The method of claim 5 comprising placing an intermediate attribute group in only one attribute group at a next higher level.

8. The method of claim 5 wherein the items are content items and the database management system is a content management system.

9. A program product comprising computer readable program code on a medium, said computer readable program code being adapted to configure and control one or ore computers to operate a relational database of items, each of said items having a plurality of attributes, said relational database operating on items as a function of the attributes of an item, said computer readable program code arraying said attributes in a hierarchal array of the attributes and levels of attribute groups, wherein an attribute group contains one or more attributes.

10. The program product of claim 9 said computer readable program code is adapted to array said attributes so that an attribute is contained in only one first level attribute group.

11. The program product of claim 9 wherein said computer readable program code is adapted to array said attributes so that an intermediate attribute group is contained in only one attribute group at a next higher level.

12. The program product of claim 9 wherein the items are content items.

13. The program product of claim 9 wherein the computer readable program is compressed, encrypted, or compressed and encrypted and requires installation to control and configure one or more computers.

14. The program product of claim 13 wherein the program code resides on an installation server before installation.
